(19) United States
(12) Patent Application Publication
(10) Pub. No.: US 2009/0218029 A1
(43) Pub. Date: Sep. 3, 2009

(54) Process for transforming printed works to a composition of tiles

(76) Inventors: Ezer Cohen, North Hollywood, CA (US); Joseph David Cohen, North Hollywood, CA (US)

Correspondence Address: Joseph David Cohen, 6113 Bluebell Avenue, North Hollywood, CA, 91606, US

(21) Appl. No.: 12/072,699

(22) Filed: Feb. 28, 2008

(51) Int. Cl. B44C 3/12

(52) U.S. Cl. 156/63

(57) ABSTRACT

A process for Transforming the Image from a “Printed Work” (Art Prints, Posters, Paper Poster, or Photographic Print, etc.) to a Composition of Tiles. The process involves cutting the “Printed Work” into separate geometric shapes (each known as a “Printed Work Section”) that each is then adhered to a “Substrate” of corresponding shape. The combination of the “Printed Work Section” and its corresponding “Substrate” is referred to as a “Tile”. Each individual “Tile” is then glued onto a “Mounting Board” to comprise the “Composition of Tiles” such that the “Image” is representative of the original “Printed Work”.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Art and more specifically to a process that Transforms a Printed Work to a Composition of Tiles.

The Poster, Art Print, or other forms of Printed Work affords the availability of mass producing Works of Art and make it available at a reasonable price to consumers. An of shoot of this is the emergence of the Canvas Transfer process that is used to transfer the Printed Work onto a Canvas and make it appear as a real life painting. While the aforementioned has been an affordable means of acquiring art for most individuals, there is still a form of reproduction of Art that is expensive to produce and not generally affordable to most, that is the reproduction of Art on Tiles.

The appeal of representing reproductions on Tile is that the Tiles are beautiful, shiny, and can are generally more durable. Reproducing Art on Tile has been generally available for some time, through Serigraphy, Tile manufacturers are able to place an image on Tile using the traditional methods of working with Ceramics. Recently, the reproduction of Art on Tiles has been made slightly more affordable and more accessible through the use of Dye sublimation technology.

Art reproduction on tile today presents various challenges: It is expensive (compared to other forms of reproduction), it is heavy, and it requires expensive machinery or artisan labor to produce. Additionally, because of its weight, Art on Tile are meant to be installed on the walls or floors such that it becomes part of the wall or floor.

Furthermore, the weight of the tiles makes it difficult and more expensive to transport. These shortcomings make Art on tile inaccessible to most who wish to decorate their homes.

Another challenge involved in reproducing art on tile is the acquisition of copyright permissions from the artist or agency. Generally, to reproduce art on tile in fine quality it requires the acquisition of the rights from the owning agency or artist (if still alive) to reproduce at least one piece of art work. Since Art on Tile is generally built to order, the availability of numerous masterpieces is limited to the number that an Art on tile manufacturer is willing to invest in. This makes their process very selective and limiting in diversity.

Yet another short coming of Art on Tile today is that the Original Work that is being reproduced is generally cropped to fit in the composition of tiles because the tiles come in fixed sizes. Art on Tile almost always forces the artwork to be cropped or trimmed from its original because the dimensions of the standard tiles in ceramics and glass don't always correspond to the dimensions or proportions of the original art work. Hence a need arises to provide a Art on Tile that is light, reasonably affordable, generally accessible, inexpensive to transport, with a Composition of Tiles that does not lead to cropping and that allows the consumer to choose from a greater number of art works generally available in the marketplace.

### BRIEF SUMMARY OF THE INVENTION

The primary object of the invention is To provide an aesthetically pleasing presentation of a “Printed Work” into a “Composition of Tiles”

Another object of the invention is To provide a method of manufacture whereby an existing “Printed Work” or the “Image” of an existing “Printed Work” is Transformed to a “Composition of Tiles”.

Another object of the invention is To provide a method of manufacture that is based on producing one-ofs of unique “Printed Works” such that a large printing run is not required to make it cost effective or profitable.

A further object of the invention is To provide a method of manufacture that allows Tiles to be made of a “Substrate” that is not based on Ceramic or Glass.

Yet another object of the invention is To provide a “Composition of Tiles” that can be framed and hung on a wall just as a regular painting.

Still yet another object of the invention is To provide a product that is light, easy to package and is cost effective to transport.

Another object of the invention is To provide a method of manufacture that allows for the “Tile” to have a custom shape and/or size.

Another object of the invention is To provide a product that is a “Composition of Tiles” that does not necessarily crop the original “Printed Work”.

A further object of the invention is To provide a product whereby each individual “Tile” can be seen as a distinct unit that forms part of a “Composition of Tiles” forming the bigger picture represented by the “Printed Work”.

Yet another object of the invention is To provide a product where each individual “Tile” has a smooth watery surface that is shiny, relatively hard, and scratch resistant.

Still yet another object of the invention is To provide a product that is a “Composition of Tiles” whereby the separation between each “Tile” can be filled with “Grout”.

Other objects and advantages of the present invention will become apparent from the following descriptions, taken in connection with the accompanying drawings, wherein, by way of illustration and example, an embodiment of the present invention is disclosed.

The uniqueness of this invention is that it transforms a “Printed Work” into a “Composition of Tiles”. This invention comprises the steps of: cutting the “Printed Work” into geometric/organic shapes; cutting the “Substrate” into corresponding geometric/organic shapes; gluing the geometric/organic shapes of the “Printed Work” onto the corresponding Substrate material of the same size to form a individual “Tile”, and repeating this process for all the shapes; The “Tiles” are then coated using a clear Resin or Epoxy that will harden to a transparent protective coating; The individual “Tiles” are then assembled on a “Mounting Board” by gluing the “Tiles” on the “Mounting Board” such that the image in the “Printed Work” is reconstructed, thus forming the “Composition of Tiles”; Optionally, the gap between the “Tiles” in the “Composition of Tiles” can be filled with grout or similar material; The “Composition of Tiles” are given another coating of protective paint or resin. The final assembly is a “Printed Work” that has been transformed into a “Composition of Tiles” while the preserving the Image.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of a sample “Printed Work”.

FIG. 2 is a plan view of a sample “Printed Work” cut up in to geometric shapes comprising the “Printed Work Sections”.

FIG. 2a is a plan view of a sample “Printed Work” cut up in to organic shapes comprising the “Printed Work Sections”.

FIG. 2b is a plan view of a sample “Printed Work” cut up in to geometric shapes of varying sizes comprising the “Printed Work Sections”.

FIG. 3 is an elevational view of a “Substrate”.

FIG. 4 is a cross sectional view of the “Substrate”.

FIG. 5 is a cross sectional view of the “Substrate” after reshaping the edges.

FIG. 6 is a cross sectional view of a “Tile”.

FIG. 7 is a plan view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

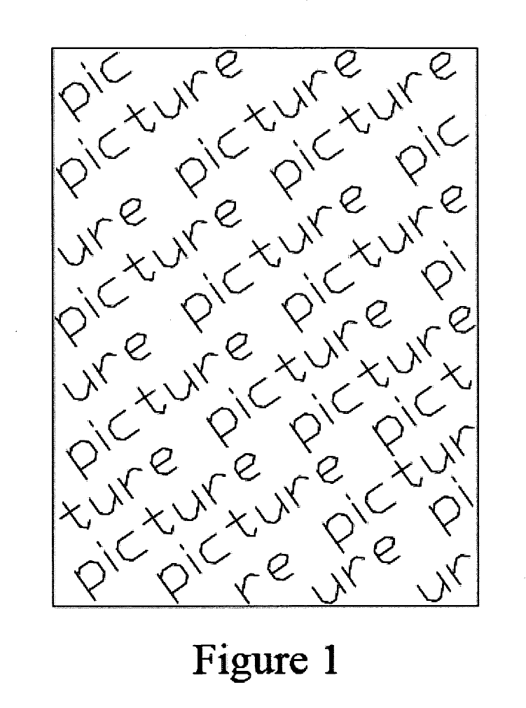

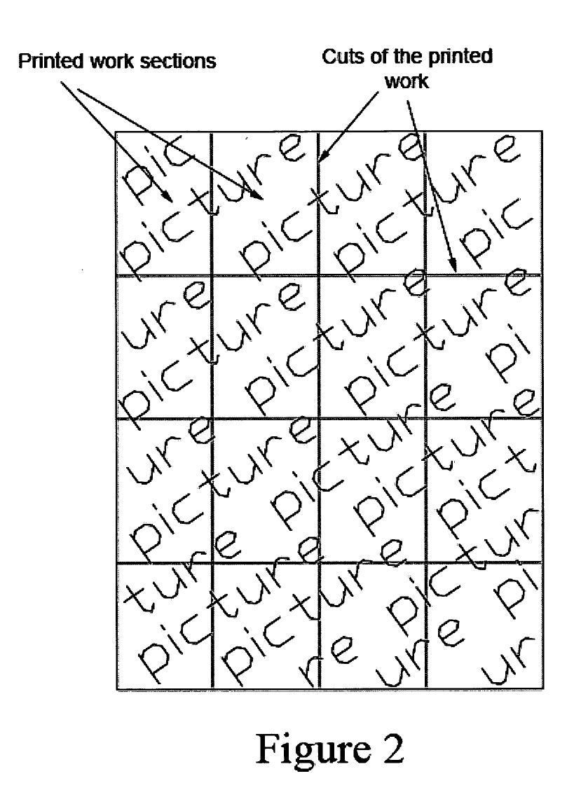

One embodiment of the “Composition of Tiles” is illustrated and described herein. In general, this invention covers a process and series of steps that transform an existing “Printed Work” (FIG. 1) into a “Composition of Tiles” (FIG. 9).

The “Printed Work” (FIG. 1) can be any image printed on paper or foil, including a Photograph, Poster, Lithograph, Art Print, Giclée Print, Printed Foil or any other image on paper or foil as preferred by an individual.

The “Printed Work” is cut into a plurality of “Cutouts”. It should be noted that the preferred instrument for cutting the “Printed Work” may be a blade, scissors, die cut machine, or any other cutting device as preferred by an individual. It should be noted that laying out the “Cutouts” side by side will be representational of the original “Printed Work”. It should be further noted that the “Cutouts” may have any desired artistic shape as preferred by an individual including but not limited to squares, triangles, rectangles, other geometric shapes, organic linear shapes, and/or any other design as desired by an individual. It should be further noted that the artistic design elements selected for the cutouts may be repetitive or non-repetitive at the discretion of an individual.

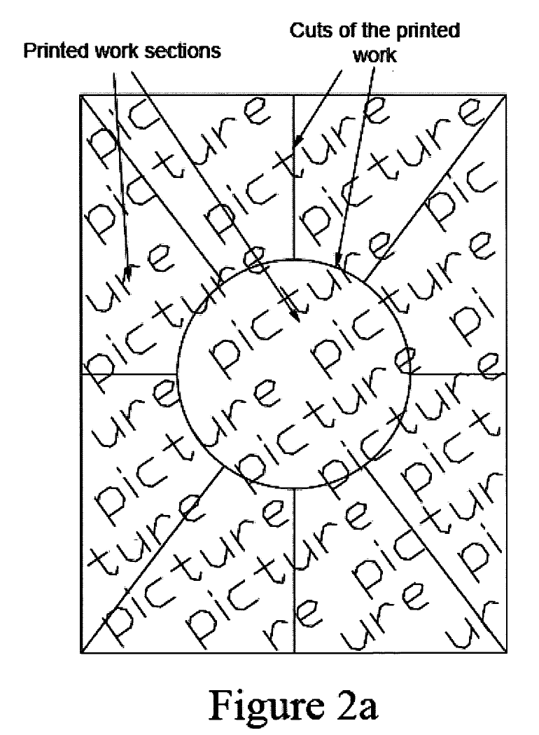

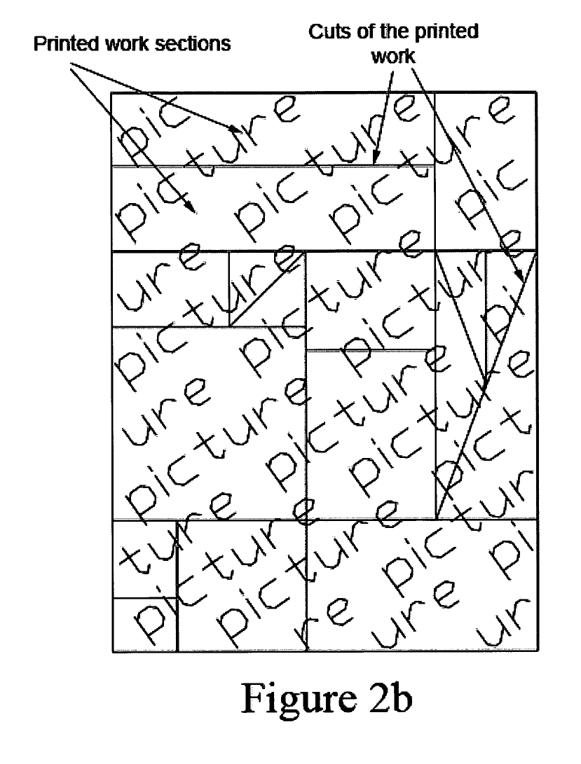

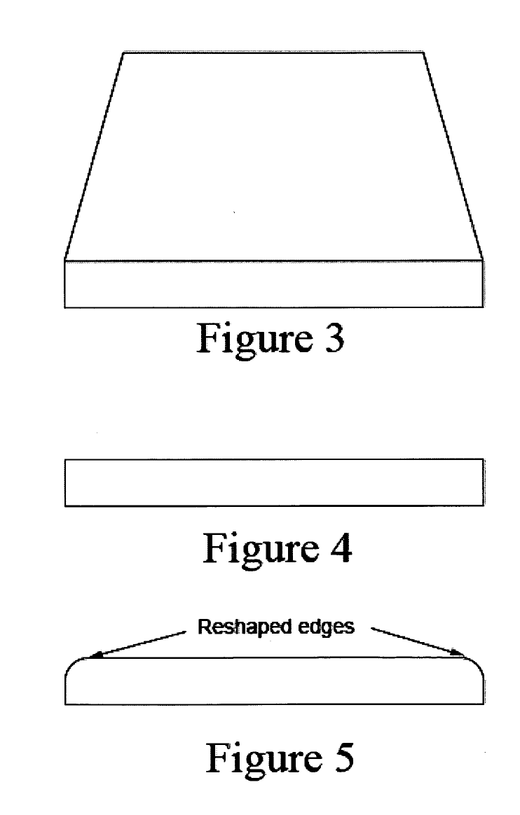

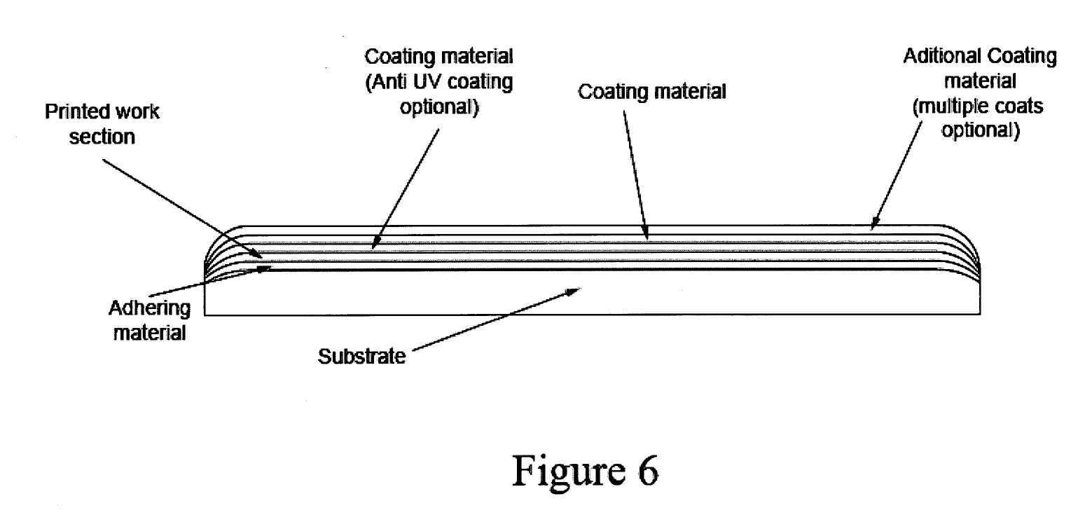

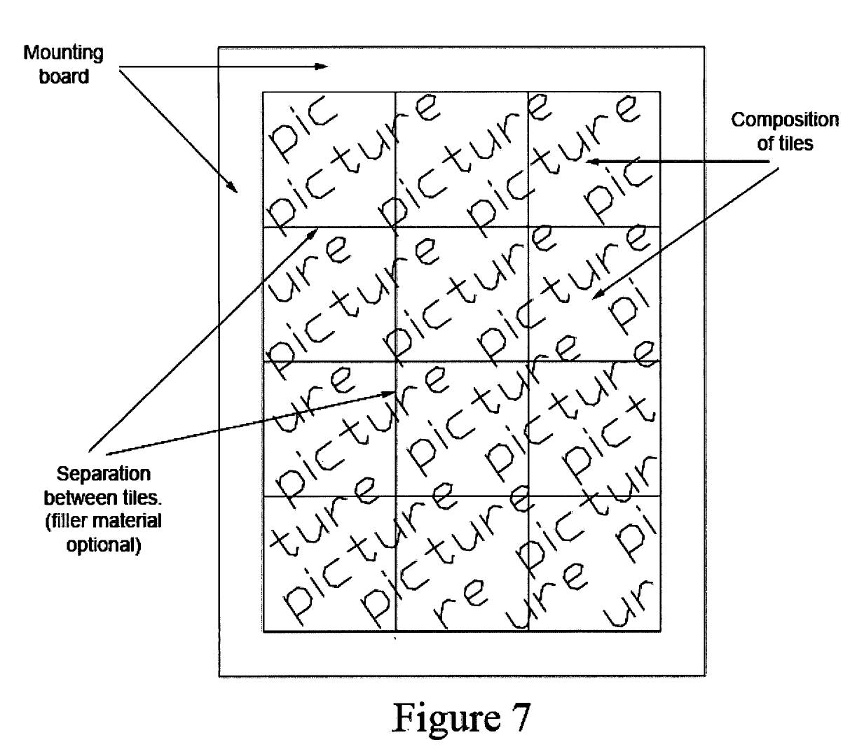

The material selected for the “Substrate” of the “Tile” is formed of cardboard, wood, glass, polyester, plastic, metal, brass, aluminum, copper, Corian, Surrell, Avonite or any other material as preferred by an individual. Each “Substrate” (FIG. 3.) must be cut to the same size, in terms of height and width, as its corresponding “Printed Work Section”.

The material selected for the “Mounting Board” where the “Composition of Tiles” is assembled is formed of cardboard, wood, plastic, metal, brass, aluminum, copper, corian, surrel, avonite, or any other material as preferred by an individual. The size of the “Mounting Board” in terms of height and width should correspond to the desired height and width of the “Final Product”.

The adhering material selected to bond the “Printed Work Section” to its corresponding “Substrate” can be formed of epoxy, contact cement, liquid nails, silicone, or any other material as preferred by an individual.

The adhering material selected to bond the Tiles to the “Mounting Board” can be preferably formed of epoxy, contact cement, liquid nails, silicone, or any other material as preferred by an individual.

A filler material can be placed between the Tiles in the “Composition of Tiles”. The material selected as filler can be preferably formed of grout, epoxy, silicone, polyester, or any other material as preferred by an individual.

The material selected to provide a protective coating to the “Tile” can be preferably formed of clear or translucent paint, epoxy, polyester, resin, or any other material as preferred by the individual. It should be noted that each individual “Tile” can be coated on the front face and/or rear of the tile. It should further be noted, that multiple coats can be applied to provide additional protection, thickness and beauty.

The first step of manufacture is to select a “Printed Work” and then cut the “Printed Work” into a plurality of cutouts that will comprise the front face of the “Tiles”.

The second step of manufacture is to cut a corresponding number of Substrates into a shape that corresponds to each “Cutout” in the first step of manufacture.

The third step of manufacture is to shave, route, or laser the edges of each “Substrate” (FIG. 3). It should be noted that if the individual desires a flat surface then this step is not required.

The fourth step of manufacture is to adhere or glue the “Cutout” to its corresponding “Substrate” and then applying extra pressure on the edges so that the “Cutout” contorts to the edges of the “Substrate”. It should be noted that this step can also include coating the “Cutout” surface with a coating material after the “Cutout” has been glued onto the “Substrate”. It should be further noted that this step results in a set of “Tiles” that can now be assembled onto a “Mounting Board”.

The sixth step of manufacture is to assemble the “Tiles” on the “Mounting Board” by gluing the “Tiles” in the proper order on to the “Mounting Board”. It should be further noted that the “Tiles” should be assembled so that the resulting image is representative of the image in the original “Printed Work”. Alternatively, the “Tiles” can be assembled on the “Mounting Board” with a slight separation between each “Tile” so that a filler material can be placed between the “Tiles”.

The seventh step of manufacture is to place a filler material between the “Tiles”. It should be noted that this step can be skipped as preferred by the individual.

The eight step of manufacture is to apply one or more coats of material on the “Composition of Tiles” and allow for curing between each coat as prescribed by the coating material selected as preferred by the individual.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for Transforming Printed Works to a Composition of Tiles comprising the steps of:
(Step 1) The “Printed Work” is cut into separate smaller sections using a cutting device. Each individual section of the “Printed Work” is referred to as the “Printed Work Section”;
(Step 2) The “Substrate” is cut into a shape that corresponds to the shape of the “Printed Work Section”. This step is repeated for each “Printed Work Section”.
(Step 3) Each “Substrate” can be re-shaped on all its edges;
(Step 4) Each “Printed Work Section” is glued or adhered to its corresponding “Substrate” (this combination is the “Tile”);
(Step 5) Each “Tile” is glued or adhered on the “Mounting Board” to create the “Composition of Tiles” such that it is representative of the “Image” in the “Printed Work”;
(Step 6) The “Composition of Tiles” is coated by applying a Resin, Epoxy or other liquid coating that will harden to a relatively thick and hard transparent layer.
(Step 7) The “Composition of Tiles” is then coated with a UV protective coating to provide Ultraviolet Radiation protection for the underlying “Printed Work” and also serves to provide for a wet look finish;

2. A process for Transforming Printed Works to a Composition of Tiles as claimed in claim 1 further comprising wherein said Step 1 can be cut into identical or diverse geometric or organic shapes such that the original “Printed Work” is not cropped.

3. A process for Transforming Printed Works to a Composition of Tiles as claimed in claim 1 further comprising wherein said Step 1 can be cut into identical geometric shapes or diverse geometric or organic shapes that do crop the original “Printed Work”, such that the “Image” on the “Composition of Tiles” is a subset of the original “Printed Work”.

4. A process for Transforming Printed Works to a Composition of Tiles as claimed in claim 1 further comprising wherein said Step 1 and Step 2 can be substituted using the comprising steps of:
(Step 1) The “Printed Work” is temporarily adhered to a “Substrate” and both are simultaneously cut into identical or diverse geometric shapes such that the original “Printed Work” is not cropped.
(Step 2) The “Printed Work Section(s)” are separated from the “Substrate Section(s)”

5. A process for Transforming Printed Works to a Composition of Tiles as claimed in claim 3 further comprising wherein said Step 3 wherein said step can be reshaped on the edges so that the edges are either angled or rounded.

6. A process for Transforming Printed Works to a Composition of Tiles as claimed in claim 1 further comprising wherein said Step 3 is skipped.

7. A process for Transforming Printed Works to a Composition of Tiles as claimed in claim 1 further comprising wherein said Step 4 involves permanently adhering each “Printed Work Section” to its corresponding “Substrate”.

8. A process for Transforming Printed Works to a Composition of Tiles as claimed in claim 7 further comprising wherein said adhesion of each “Printed Work Section” conforms to the contours of its corresponding “Substrate”.

9. A process for Transforming Printed Works to a Composition of Tiles as claimed in claim 1 further comprising that prior to Step 5 each individual “Tile” can be coated using a Resin, Epoxy or other liquid coating such that the coating covers all of the visible portion of the tile and all or part of the underlings of each individual “Tile”.

10. A process for Transforming Printed Works to a Composition of Tiles as claimed in claim 1 further comprising that Step 6 can include any form of coating, that will result in a transparent protective layer.

11. A process for Transforming Printed Works to a Composition of Tiles as claimed in claim 10 further comprising that the coating can be translucent, such that part or all of the original “Printed Work” is visible through the coating.

12. A process for Transforming Printed Works to a Composition of Tiles as claimed in claim 1 Step 5 further comprising the steps of:
(Step 5a) Each “Tile” is glued or adhered on the “Mounting Board” with a slight separation between each tile;
(Step 5b) A material that can appear to be grout is used to fill in the separation between the “Tiles” on the “Composition of Tiles”.

13. A process for Transforming Printed Works to a Composition of Tiles as claimed in claim 1 further comprising wherein said Step 6 and Step 7 that the coating material can be such that it provides all the qualities of Step 6 and Step 7 in one single Step.

14. A process for Transforming Printed Works to a Composition of Tiles as claimed in claim 1 in Step 4 where alternatively the “Image” from each “Printed Work Section” is lifted from the paper and glued to its corresponding “Substrate”.

15. A process for Transforming Printed Works to a Composition of Tiles as claimed in claim 4 where alternatively the “Image” from the “Printed Work” is lifted from the paper.
